(19) United States
(12) Patent Application Publication
(10) Pub. No.: US 2012/0203703 A1
(43) Pub. Date: Aug. 9, 2012

(54) Method for Negotiating Information Technology Service Processes

(75) Inventors: Ramendra K. Sahoo, Mohegan Lake, NY (US); Anees A. Shaikh, Yorktown Heights, NY (US)

(73) Assignee: INTERNATIONAL BUSINESS MACHINES CORPORATION, Armonk, NY (US)

(21) Appl. No.: 13/453,310

(22) Filed: Apr. 23, 2012

Related U.S. Application Data
(62) Division of application No. 12/099,820, filed on Apr. 9, 2008.

(51) Int. Cl. G06Q 10/06

(52) U.S. Cl. 705/80

(57) ABSTRACT

Techniques for establishing a performance metric are provided for facilitating a negotiation between a provider and a user. The techniques include the following steps. Resource utilization is calculated, wherein resource utilization comprises system capacity utilized for executing a task. Work lost is calculated, wherein work lost comprises an amount of work lost as a result of a potential failure. Quality of service (QoS) is calculated, wherein QoS comprises a probability of success for executing the task by a deadline. User behavior is calculated, wherein user behavior comprises an amount of risk that the user is willing to accept. Also the calculated resource utilization, work lost, QoS and user behavior are used to establish a performance metric, wherein the performance metric facilitates a negotiation between a provider and a user.

### CROSS-REFERENCE TO RELATED APPLICATIONS

This application is a divisional of U.S. patent application Ser. No. 12/099,820, filed Apr. 9, 2008, incorporated by reference herein.

### FIELD OF THE INVENTION

The present invention generally relates to information technology, and, more particularly, to enterprise processes.

### BACKGROUND OF THE INVENTION

In an on-demand market place with dynamically changing customer requirements, it is not unusual that either the service providers or the customers incur heavy losses due to the occurrence of expected or unexpected failures in process execution. For example, sales and marketing teams can promise too much to the customers without realizing the consequences of contractual details in case there are unexpected incidences hampering the satisfaction of delivery deadlines with expected quality.

Also, for example, the traditional enterprise process contractual agreements do not have fall-back or negotiation details associated with unexpected failures apart from the service delivery deadlines and associated quality standards, if any. Moreover, many customers or services provider become pressured to provide many extraneous services beyond what a nearest prevailing competitor can provide. Similarly, for the customer, it is also difficult for a customer to get exactly what he or she is looking for in terms of services. As a result, both customer(s) and service provider(s) have to work through a wide range of choices before finalizing any deals.

### SUMMARY OF THE INVENTION

Principles of the present invention provide techniques for negotiating information technology (IT) service processes. An exemplary method (which may be computer-implemented) for establishing a performance metric, according to one aspect of the invention, can include the following steps. Resource utilization is calculated, wherein resource utilization comprises system capacity utilized for executing a task. Work lost is calculated, wherein work lost comprises an amount of work lost as a result of a potential failure. Quality of service (QoS) is calculated, wherein QoS comprises a probability of success for executing the task by a deadline. User behavior is calculated, wherein user behavior comprises an amount of risk that the user is willing to accept. Also the calculated resource utilization, work lost, QoS and user behavior are used to establish a performance metric, wherein the performance metric facilitates a negotiation between a provider and a user.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a mode of enterprise process transactions to accommodate deadlines, outputs and quality, according to an embodiment of the present invention;

FIG. 2 is a diagram illustrating goods and services components, according to an embodiment of the present invention;

FIG. 3 is a diagram illustrating user behavior as a function of a probability factor and a deadline, according to an embodiment of the present invention;

FIG. 4 is a flow diagram illustrating techniques for negotiating an agreement between a provider and a user, according to an embodiment of the present invention;

FIG. 5 is a flow diagram illustrating techniques for establishing a performance metric, according to an embodiment of the present invention; and

FIG. 6 is a system diagram of an exemplary computer system on which at least one embodiment of the present invention can be implemented.

### DETAILED DESCRIPTION OF PREFERRED EMBODIMENTS

Principles of the present invention include techniques for improving services quality through probabilistic, mutually-agreeable market-based and on-demand risk strategies. One or more embodiments of the invention relate efficient enterprise process orchestration to meet deadlines and quality standards in a realistic marketplace, dealing with expected and/or unexpected failures in process execution. For example, one or more embodiments of the invention establish metrics, and propose techniques allowing the service provider and customer to negotiate by way of mutually-agreeable risk strategies to accomplish the desired goal.

Enterprise processes should advantageously be able to reliably and efficiently orchestrate assigned tasks to meet deadlines and quality standards, even in the presence of expected or unexpected failures in process executions. One or more embodiments of the present invention include details of a metric and techniques facilitating negotiations and/or deals in instances of expected and/or unexpected failures. The techniques described herein allow the services provider and customers to negotiate by way of mutually-desirable risk strategies in order to accomplish desired goals in case there are failures.

Also, one or more embodiments of the invention provide probabilistic service quality guarantees in the form services ‘s’ that can be completed by deadline ‘d’ with a probability ‘p.’ In order to make such guarantees, the techniques described herein can use, for example, forecasting techniques in conjunction with service level agreements and strategies used by both a services provider and a consumer to arrive at a desired level of balance between quality of services, service level agreement and service delivery guarantees. Such a mechanism, driven by market-based and demand-driven techniques, can arrive at some intermediate stage, while not only continually improving the performance metrics, but also safeguarding both services providers and consumers in case there are failures which might lead to losses on both ends.

For many services related customer engagements leading to service level agreements, decisions on the part of either the users or service providers can be uninformed. The techniques described herein address challenges associated with quality of service (QoS) guarantees (such as, for example, deadlines) in the presence of expected and/or unexpected failures.

Users cannot decide their own deadlines because the service providers may not be able to satisfy their requests. On the other hand, a service provider cannot decide to push the deadlines for the users, because users may be unsatisfied with the service they receive. Similar situations are even more complex, such as, for example, when there are several quality parameters and service level indicators to be associated while preparing contract details. As a result, the process of preparing and deciding the level of promise from either a customer or service provider point-of-view can vary from person to person and the type of transaction. Due to the presence of potentially numerous details and dependencies within such contracts, in case there are failures (expected or unexpected in nature), there are generally no provisions for a defined mechanism to resolve and make sure either one side or both sides deal with severe penalties.

One or more embodiments of the present invention provide a mechanism for service providers and users to cooperate in order to devise a mutually desirable risk strategy. One possible semantic for this cooperation is, for example, for the services to make guarantees in the form of, “service s can be completed by deadline d with probability p.” Within such a process, there can exist a market-based interaction where users have an incentive to relax their deadlines. As a consequence, the service provider has flexibility and the users have more personalized service.

As described herein, a service provider can rely on a forecasting mechanism to estimate the probability that the deadline will be met. If the resources are to be used in a realistic on-demand environment, service providers can, for example, make QoS guarantees to users, similar to the deadlines. Deadlines are important for the end-user who may not be concerned about overall working and quality of services. Normally, the users see any latency, and not the throughputs associated with service delivery processes. For example, sometimes deadlines are difficult to meet, in part due to the presence of expected or unexpected failures.

Besides the obvious performance hit, failures often lead to irreparable relationship damages, pushing either the customers or service providers away from each other. As a result, for today's business environments dominated by service interactions, the techniques described herein provide a mechanism for any QoS promise to be accompanied either by the conditions under which the promise can be kept, or with a probabilistic confidence in the guarantee. No real system can promise a level of performance with 100% confidence, because any component or set of components may fail without warning.

A service provider tries to minimize P_{f}, the probability that a service provider would fail to provide the services due to failures at some point. P_{f} can be calculated, for example, using a number of forecasting techniques and parameters from previous similar engagements. Because P_{f} is deadline-dependent, a service provider can also, for example, suggest a deadline for the user, citing the increased probability of success as a motivating factor. For instance, when a customer requests services and there are surplus resources for a similar work order, the service provider would have the lowest probability of failure. If such probability and deadline are acceptable to the user, the service level agreements can be signed. Otherwise, the user may agree to a later deadline in exchange for a greater probability of success.

As detailed herein, one or more embodiments of the invention include negotiations and QoS metrics. For example, a unique dialog between the service provider and the user occurs, wherein the service provider and user negotiate a deadline. Users are given an incentive to relax their deadlines in order to attain higher probabilities of success.

As an example, consider the following situation. A user-submitted request with a tight deadline would put pressure on prioritizing resources for the work with a question such as, for example, “How likely is it that the work is going to be successful while simultaneously other work orders are to be fulfilled?” A forecasting technique could provide answers such as, for example that the work order can be completed by the given deadline with probability p1, but relaxing the deadline to a later time, such as td, increases the probability of success to p2 (where p2>p1). In this way, the user is given an accurate sense of how likely it is that his request will be filled, and he is given incentive to relax his requirements.

One or more embodiments of the present invention also include resource utilization. System capacity utilized and work lost are calculated based on the following formulations. A unit of work to be carried out by one resource within one unit time is defined. If T denotes the time span, and N is the number of resources associated therewith, then the capacity utilized (Wᵤₜᵢ₁) is the ratio of work accomplished to work power available. That is, imagine that all work orders had arrived simultaneously and were completed without failure, and that the system was being used at 100% capacity the entire time. Utilization is the ratio of actual behavior to that behavior, and calculated as follows:

$${W}_{util} {\sum }_{{∀}_{j}} \frac{{e}_{j} {n}_{j}}{TN}$$

Additionally, the techniques described herein include a measure of work lost. Let tₓ be the time of failure x, and jₓ be the job that fails as a result of x (jₓ may be null). If cⱼₓ is the time at which the last successful checkpoint for jₓ started, and nⱼₓ is the size of jₓ in nodes, then the amount of work lost as a result of failure x is (tₓ−cⱼₓ)nⱼₓ (this equals 0 for jₓ=null). Hence, the total work lost (Wₗₒₛₜ) is calculated by the following equation:

$${W}_{lost} = {\sum }_{∀ x} ( {t}_{k} - {c}_{{j}_{x}} ) {n}_{{j}_{x}}$$

One or more embodiments of the invention also include a QoS metric. A QoS metric can be measured, for example, as follows. Let eⱼ be the execution time, and nⱼ be the size in nodes. Let qⱼ be an indicator variable such that qⱼ=1 if j finishes by its deadline, and 0 otherwise. Let pⱼ be the probability of success for j that the system promised the user at submission time. Thus, QoS can be defined as:

$$QoS = \frac{{\sum }_{j} {e}_{j} {n}_{j} {q}_{j} {p}_{j}}{{\sum }_{j} {e}_{j} {n}_{j}}$$

In order to test the behavior of a system under a large variety of parameters, user behavior is considered as one of the primary factors. Because the techniques described herein rely on a dialogue between the user and service provider in which a deadline and promised probability of success are negotiated, user behavior can be defined in terms of these values (that is, p and d; Uⱼ=f(pⱼ, dⱼ)). For example, user behavior can be defined by a parameter U, which relates to the amount of risk the user is willing to accept. For a given service s, with promised probability of success pⱼ, a user will accept the earliest deadline such that pⱼ≧U. Thus, U ranges from 0 to 1. As an example, U=0.5 implies that all users will extend their deadline as little as possible in order to expect at least a 50% chance of success.

Thus, a deadline may be pushed arbitrarily far into the future, but no further than necessary to satisfy the QoS equation (noted above). If one assumes “a” to be the probability of availability of IT services without any increase in marginal cost and within the desired profit margin level (for the service provider), for any value of “a” where the corresponding “U”>U from the consumer side, the terms and conditions would not be agreeable. As a result, either side would have to relax the limits so that they would converge to an equilibrium point.

FIG. 1 is a diagram illustrating a mode of enterprise process transactions to accommodate deadlines, outputs and quality, according to an embodiment of the present invention. By way of illustration, FIG. 1 depicts a customer 102 providing payments to a service provider 104, wherein the service provider 104 provides goods and services to the customer 102.

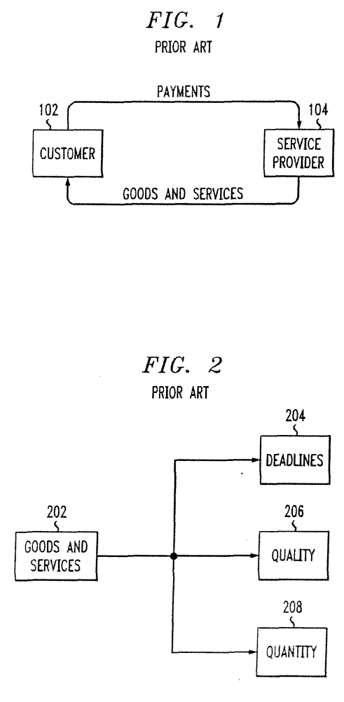

FIG. 2 is a diagram illustrating goods and services components, according to an embodiment of the present invention. By way of illustration, FIG. 2 depicts the elements of goods and services 202, deadlines 204, quality 206 and quantity 208. Factors beyond the control of enterprise transactions include, for example, market conditions and natural disasters.

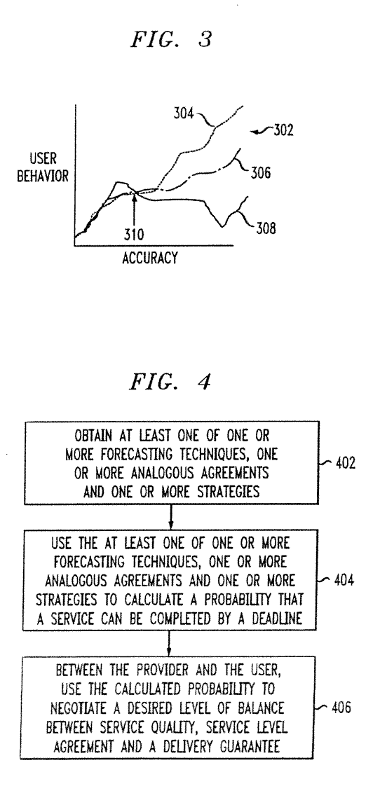

FIG. 3 is a diagram illustrating user behavior as a function of a probability factor and a deadline, according to an embodiment of the present invention. By way of illustration, FIG. 3 depicts a graph 302 that includes lines 304, 306 and 308, where 304, 306 and 308 represent deadline (d) corresponding to too short deadline, medium range deadline and too long deadline, respectively. Moreover, point 310 represents the point at which all three curves intersect each other, representing the equilibrium point mutually satisfying both the customer and service provider.

FIG. 4 is a flow diagram illustrating techniques for negotiating an agreement between a provider and a user, according to an embodiment of the present invention. Step 402 includes obtaining at least one of one or more forecasting techniques, one or more analogous agreements and one or more strategies. Forecasting techniques can include, for example, estimating profits and customer satisfaction levels based on the mutually agreeable term conditions (through information sharing), which can be beneficial for both sides.

Step 404 includes using the at least one of one or more forecasting techniques, one or more analogous agreements and one or more strategies to calculate a probability that a service can be completed by a deadline. Calculating a probability that a service can be completed by a deadline can include accounting for expected and/or unexpected failures. Step 406 includes between the provider and the user, using the calculated probability to negotiate a desired level of balance between service quality, service level to agreement and a delivery guarantee.

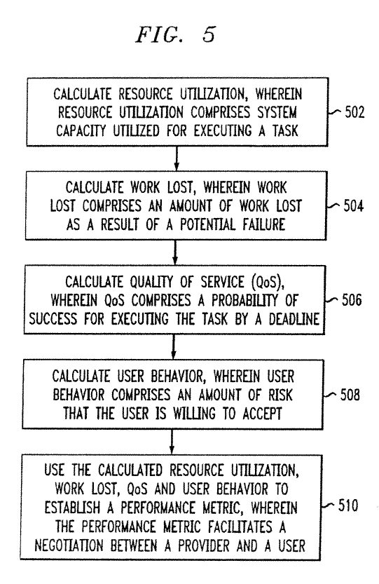

FIG. 5 is a flow diagram illustrating techniques for establishing a performance metric, according to an embodiment of the present invention. Step 502 includes calculating resource utilization, wherein resource utilization comprises system capacity utilized for executing a task. Calculating resource utilization includes using an equation

$${W}_{util} {\sum }_{{∀}_{j}} \frac{{e}_{j} {n}_{j}}{TN} ,$$

wherein eⱼ and nⱼ represent the effective portion of time of any particular task and how many resources of similar nature are utilized, and T and N represent the total assigned time and total number of resources associated therewith.

Step 504 includes calculating work lost, wherein work lost can include an amount of work lost as a result of a potential failure. Calculating work lost includes using an equation

$${W}_{lost} = {\sum }_{∀ x} ( {t}_{k} - {c}_{{j}_{x}} ) {n}_{{j}_{x}} ,$$

wherein tₓ represents a time recorded as the time used to carry out the task x, ⱼ_{ₓ} represents a task that fails as a result of x, cⱼ_{ₓ} represents a time which was recorded based on past record and nⱼ_{ₓ} represents the number of resources utilized.

Step 506 includes calculating quality of service (QoS), wherein QoS can include a probability of success for executing the task by a deadline. Calculating quality of service (QoS) can include using an equation

$$QoS = \frac{{\sum }_{j} {e}_{j} {n}_{j} {q}_{j} {p}_{j}}{{\sum }_{j} {e}_{j} {n}_{j}} ,$$

wherein eⱼ represents an execution time for task j, nⱼ represents the number of resources utilized, qⱼ represents an indicator variable such that qⱼ=1 if j finishes by its deadline, and 0 otherwise and pⱼ represents a probability of success for j by a deadline time.

Step 508 includes calculating user behavior, wherein user behavior can include an amount of risk that the user is willing to accept. Calculating user behavior can include using an equation Uⱼ=f(pⱼ, dⱼ), wherein pⱼ represents the promised probability of success and dⱼ represents the promised deadline acceptable for the consumer. Step 510 includes using the calculated resource utilization, work lost, QoS and user behavior to establish a performance metric, wherein the performance metric facilitates a negotiation between a provider and a user.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

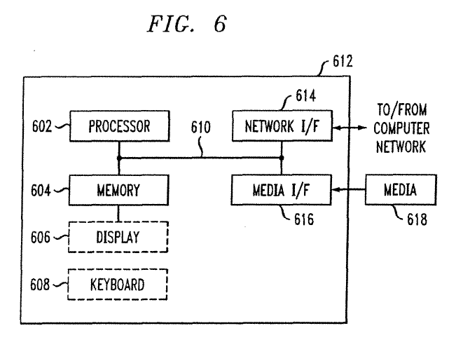

At present, it is believed that the preferred implementation will make substantial use of software running on a general-purpose computer or workstation. With reference to FIG. 6, such an implementation might employ, for example, a processor 602, a memory 604, and an input and/or output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 602, memory 604, and input and/or output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 618) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 604), magnetic tape, a removable computer diskette (for example, media 618), a random access memory (RAM), a read-only memory (ROM), a rigid magnetic disk and an optical disk. Current examples of optical disks include compact disk-read only memory (CD-ROM), compact disk-read and/or write (CD-R/W) and DVD. A data processing system suitable for storing and/or executing program code will include at least one processor 602 coupled directly or indirectly to memory elements 604 through a system bus 610. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, relating efficient enterprise process orchestration to meet deadlines and quality standards in a realistic marketplace, dealing with expected and/or unexpected failures in process execution.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for establishing a performance metric, comprising the steps of:
calculating resource utilization, wherein resource utilization comprises system capacity utilized for executing a task;
calculating work lost, wherein work lost comprises an amount of work lost as a result of a potential failure;
calculating quality of service (QoS), wherein QoS comprises a probability to of success for executing the task by a deadline;
calculating user behavior, wherein user behavior comprises an amount of risk that the user is willing to accept; and
using the calculated resource utilization, work lost, QoS and user behavior to establish a performance metric, wherein the performance metric facilitates a negotiation between a provider and a user.

2. The method of claim 1, wherein calculating resource utilization comprises using an equation
$${W}_{util} {\sum }_{{∀}_{j}} \frac{{e}_{j} {n}_{j}}{TN} ,$$
wherein eⱼ and nⱼ represent an effective portion of time of any particular task and how many resources of similar nature are utilized, and T and N represent a total assigned time and total number of resources associated therewith.

3. The method of claim 1, wherein calculating work lost comprises using an equation
$${W}_{lost} = {\sum }_{∀ x} ( {t}_{k} - {c}_{{j}_{x}} ) {n}_{{j}_{x}} ,$$
wherein tₓ represents a time recorded as the time used to carry out a task x, ⱼ_{ₓ} represents a task that fails as a result of x, cⱼ_{ₓ} represents a time which was recorded based on past record and nⱼ_{ₓ} represents a number of resources utilized.

4. The method of claim 1, wherein calculating quality of service (QoS) comprises using an equation
$$QoS = \frac{{\sum }_{j} {e}_{j} {n}_{j} {q}_{j} {p}_{j}}{{\sum }_{j} {e}_{j} {n}_{j}} ,$$
wherein eⱼ represents an execution time for task j, nⱼ represents a number of resources utilized, qⱼ represents an indicator variable such that qⱼ=1 if j finishes by its deadline, and 0 otherwise, and pⱼ represents a probability of success for j by a deadline time.

5. The method of claim 1, wherein calculating user behavior comprises using an equation Uⱼ=f(pⱼ, dⱼ), wherein pⱼ represents a promised probability of success and dⱼ represents a promised deadline acceptable for a consumer.

6. A computer program product comprising a computer readable medium having computer readable program code for establishing a performance metric, said computer program product including:
computer readable program code for calculating resource utilization, wherein resource utilization comprises system capacity utilized for executing a task;
computer readable program code for calculating work lost, wherein work lost comprises an amount of work lost as a result of a potential failure;
computer readable program code for calculating quality of service (QoS), wherein QoS comprises a probability of success for executing the task by a deadline;
computer readable program code for calculating user behavior, wherein user behavior comprises an amount of risk that the user is willing to accept; and
computer readable program code for using the calculated resource utilization, work lost, QoS and user behavior to establish a performance metric, wherein the performance metric facilitates a negotiation between a provider and a user.

7. The computer program product of claim 6, wherein the computer readable program code for calculating resource utilization comprises computer readable program code for using an equation
$${W}_{util} {\sum }_{{∀}_{j}} \frac{{e}_{j} {n}_{j}}{TN} ,$$
wherein eⱼ and nⱼ represent an effective portion of time of any particular task and how many resources of similar nature are utilized, and T and N represent a total assigned time and total number of resources associated therewith.

8. The computer program product of claim 6, wherein the computer readable program code for calculating work lost comprises computer readable program code for using an equation
$${W}_{lost} = {\sum }_{∀ x} ( {t}_{k} - {c}_{{j}_{x}} ) {n}_{{j}_{x}} ,$$
wherein tₓ represents a time recorded as the time used to carry out a task x, ⱼ_{ₓ} represents a task that fails as a result of x, cⱼ_{ₓ} represents a time which was recorded based on past record and nⱼ_{ₓ} represents a number of resources utilized.

9. The computer program product of claim 6, wherein the computer readable code for calculating quality of service (QoS) comprises computer readable program code for using an equation
$$QoS = \frac{{\sum }_{j} {e}_{j} {n}_{j} {q}_{j} {p}_{j}}{{\sum }_{j} {e}_{j} {n}_{j}} ,$$
wherein eⱼ represents an execution time for task j, nⱼ represents a number of resources utilized, qⱼ represents an indicator variable such that qⱼ=1 if j finishes by its deadline, and 0 otherwise, and pⱼ represents a probability of success for j by a deadline time.

10. The computer program product of claim 6, wherein the computer readable code for calculating user behavior comprises computer readable program code for using an equation Uⱼ=f(pⱼ, dⱼ), wherein pⱼ represents a promised probability of success and dⱼ represents a promised deadline acceptable for a consumer.

11. An apparatus for establishing a performance metric, comprising:
a memory; and
at least one processor coupled to said memory and operative to:
calculate resource utilization, wherein resource utilization comprises system capacity utilized for executing a task;
calculate work lost, wherein work lost comprises an amount of work lost as a result of a potential failure;
calculate quality of service (QoS), wherein QoS comprises a probability of success for executing the task by a deadline;
calculate user behavior, wherein user behavior comprises an amount of risk that the user is willing to accept; and
use the calculated resource utilization, work lost, QoS and user behavior to establish a performance metric, wherein the performance metric facilitates a negotiation between a provider and a user.

12. The apparatus of claim 11, wherein in calculating resource utilization, the at least one processor coupled to said memory is further operative to use an equation
$${W}_{util} {\sum }_{{∀}_{j}} \frac{{e}_{j} {n}_{j}}{TN} ,$$
wherein eⱼ and nⱼ represent an effective portion of time of any particular task and how many resources of similar nature are utilized, and T and N represent a total assigned time and total number of resources associated therewith.

13. The apparatus of claim 11, wherein in calculating work lost, the at least one processor coupled to said memory is further operative to use an equation
$${W}_{lost} = {\sum }_{∀ x} ( {t}_{k} - {c}_{{j}_{x}} ) {n}_{{j}_{x}} ,$$
wherein tₓ represents a time recorded as the time used to carry out a task x, ⱼ_{ₓ} represents a task that fails as a result of x, cⱼ_{ₓ} represents a time which was recorded based on past record and nⱼ_{ₓ} represents a number of resources utilized.

14. The apparatus of claim 11, wherein in calculating quality of service (QoS), the at least one processor coupled to said memory is further operative to use an equation
$$QoS = \frac{{\sum }_{j} {e}_{j} {n}_{j} {q}_{j} {p}_{j}}{{\sum }_{j} {e}_{j} {n}_{j}} ,$$
wherein eⱼ represents an execution time for task j, nⱼ represents a number of resources utilized, qⱼ represents an indicator variable such that qⱼ=1 if j finishes by its deadline, and 0 otherwise, and pⱼ represents a probability of success for j by a deadline time.

15. The apparatus of claim 11, wherein in calculating user behavior, the at least one processor coupled to said memory is further operative to use an equation Uⱼ=f(pⱼ, dⱼ), wherein pⱼ represents a promised probability of success and dⱼ represents a promised deadline acceptable for a consumer.
